(19) United States
(12) Patent Application Publication
(10) Pub. No.: US 2007/0143124 A1
(43) Pub. Date: Jun. 21, 2007

(54) Extensible object data enabled manufacturing

(75) Inventors: Eric Erhard Blouin, Ardmore, PA (US); Barry Alan Kritt, Raleigh, NC (US); Douglas Alan Law, Chapel Hill, NC (US); Thomas S. Mazzeo, Durham, NC (US); Kenneth Wayne Roberson, North Richland Hills, TX (US)

Correspondence Address: DUKE W. YEE;YEE & ASSOCIATES, P.C., P.O. BOX 802333, DALLAS, TX, 75380, US

(73) Assignee: International Business Machines Corporation, Armonk, NY (US)

(21) Appl. No.: 11/303,165

(22) Filed: Dec. 15, 2005

(51) Int. Cl. G06Q 99/00; G05B 19/418; G06F 15/02; G06F 9/46

(52) U.S. Cl. 705/1; 705/9; 705/8

(57) ABSTRACT

A computer implemented method, data processing system, and computer program product for using extensible object data (or other XML-based models of an ordered product) to directly drive manufacturing in an optimized manner. A customer order or request to create an item is received at a manufacturing facility. The customer order includes extensible object data (XOD) comprising an extensible markup language-based representation of a physical product. A production order to begin the manufacturing process is generated based on the customer order. A customized manufacturing process routing is created using XOD and an extensible translation stylesheet (XSLT), wherein the customized manufacturing process routing provides manufacturing operators with specific information regarding the process steps to manufacture items specified in the request. XOD and XSLT may also be used to create manual manufacturing instructions, trigger automated operations, and verify part number processing if part numbers are used to track customer orders.

### BACKGROUND OF THE INVENTION

1. Field of the Invention

The present invention relates generally to an improved data processing system, and in particular, to a computer implemented method, data processing system, and computer program product for using extensible object data (or other XML-based models of an ordered product) to directly drive manufacturing in an optimized manner.

2. Description of the Related Art

Manufacturing highly configured computer systems in a low-cost yet reliable manner is a complex task. Customers can personalize their systems by specifying which devices they want in their system configuration. However, many items desired by customers go beyond specifying the devices in the configuration. For instance, customers may want to specify items such as RAID (Redundant Array of Independent Disks) configuration, boot sequences, custom asset tags, custom partition sizes, specialized cabling, and the like. The customers may also want to order customized “clusters” of systems, and have the systems built as a total customer solution. Problems that exist in current manufacturing computer systems is how to capture these customer requirements, convey these complex requirements to manufacturing, and optimize the manufacturing process using these customer requirements.

A current approach used by manufacturers to solve this problem is to release a part number of some type to describe a specific configuration. For instance, a different part number can be created for every RAID configuration or boot sequence option. However, this approach does not extend well to items such as custom asset tags or partition sizes, since with these items, there are unlimited configuration choices available. Thus, with this approach, a new part number must be created as needed based on each customer's requirements. In addition, the process of setting up part numbers to assign to the customer request also adds cost and lead time to the process.

Another current approach to solve this problem is to allow customers to enter requirements free-form at order time. This approach also has drawbacks, since customers may provide incomplete, ambiguous, or unsupported requirements, which causes inefficiency in manufacturing and also results in manufactured solutions that are not what the customer intended. Additionally, there is currently no way to price these free-form inputs, since the customer is dynamically creating the order.

### BRIEF SUMMARY OF THE INVENTION

Embodiments of the present invention provide a computer implemented method, data processing system, and computer program product for using extensible object data (or other XML-based models of an ordered product) to directly drive manufacturing in an optimized manner. A customer order or request to create an item is received at a manufacturing facility. The customer order includes extensible object data comprising an extensible markup language-based representation of a physical product. A production order to begin the manufacturing process is generated based on the customer order. A customized manufacturing process routing is created using the extensible object data and an extensible translation stylesheet, wherein the customized manufacturing process routing provides manufacturing operators with specific information regarding the process steps to manufacture items specified in the request. Manual manufacturing instructions may also be created using the extensible object data and extensible translation stylesheet and provided to the manufacturing operators. The extensible object data and extensible translation stylesheet may also be used to trigger automated operations, such as verifying components are correctly assembled, configuring an item based on the customer order, updating firmware, testing the items, generating a test sequence, and the like. If a manufacturer uses part numbers to track customer orders, the extensible object data may be used to verify part number processing.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a representation of a network of data processing systems in which the present invention may be implemented;

FIG. 2 is a block diagram illustrating a data processing system in which the present invention may be implemented;

FIG. 3 is a block diagram illustrating exemplary components with which the present invention may be implemented;

FIG. 4 is a block diagram of an XOD document and its object collection and view/hierarchies object sub-units in accordance with an illustrative embodiment of the present invention;

FIG. 5 is a block diagram illustrating exemplary process routing definitions generated from the XOD document in accordance with an illustrative embodiment of the present invention; and

FIG. 6 is a flowchart of a process for using XOD to drive manufacturing operations in accordance with an illustrative embodiment of the present invention.

### DETAILED DESCRIPTION OF THE INVENTION

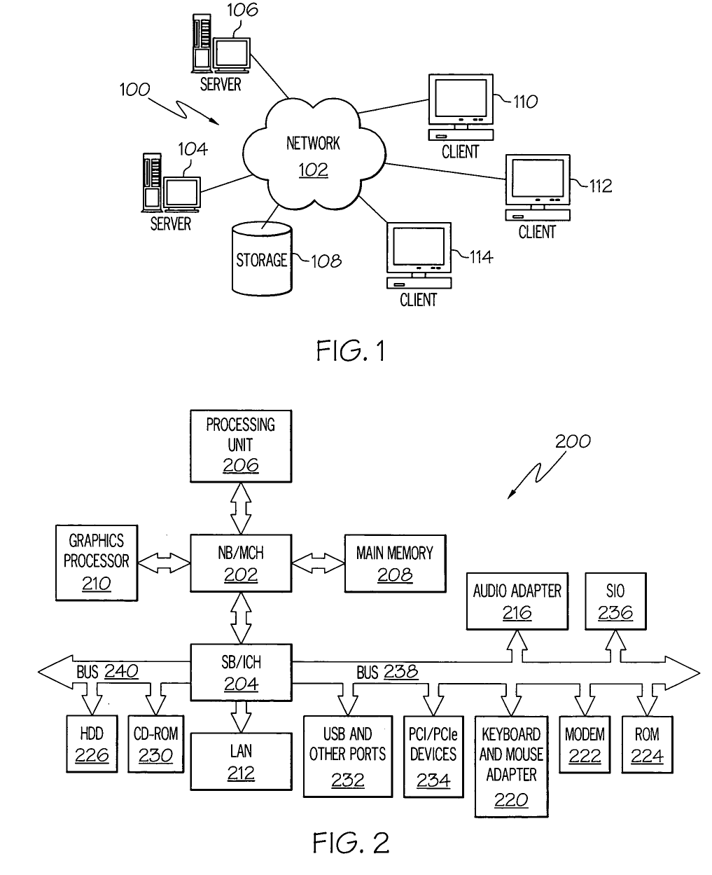

With reference now to the figures and in particular with reference to FIGS. 1-2, exemplary diagrams of data processing environments are provided in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ pSeries® computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for embodiments of the present invention are performed by processing unit 206 using computer usable program code, which may be located in a memory such as, for example, main memory 208, ROM 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course, the bus system may be implemented using any type of communication fabric or architecture that provides for a transfer of data between different components or devices attached to the fabric or architecture. A communication unit may include one or more devices used to transmit and receive data, such as modem 222 or network adapter 212 of FIG. 2. A memory may be, for example, main memory 208, ROM 224, or a cache such as found in NB/MCH 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

A customer may place an order for a highly configured computer system by specifying items the customer wants in the machine. This order information may then be provided to a manufacturing facility, which builds the computer system according to the customer specifications. Manufacturing is responsible for properly assembling, configuring, and testing solutions. This process typically involves both manual assembly, such as building the units and applying labels, and automated activities, such as verifying the electronic components have been correctly assembled, updating firmware, testing, OS preload, and the like.

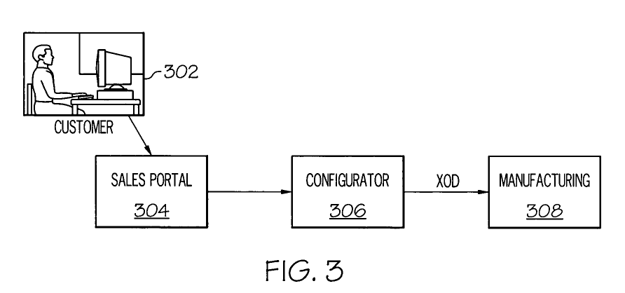

FIG. 3 is a block diagram illustrating exemplary components with which the present invention may be implemented. Customer 302 interacts with sales portal 304 via a Web service and selects a product to customize. Sales portal 304 calls configurator 306 to perform the customization of the selected product. Customer 302 may make selections to tailor the product in configurator 306. When the customer is done customizing the order, configurator 306 determines whether or not the order data is valid and safe for the sales portal 304 to hand the order off to placement and fulfillment applications, in manufacturing 308. These validations may be used to update the order data to reflect any detected changes and validation results. If the order/configuration is valid, configurator 306 builds an XML-based document, or extensible object data (XOD) document, from the information in the validated order data. The configurator 306 then provides the XML-based document to manufacturing 308. Manufacturing 308 may then use the XML-based document to create assembly instructions and to control automated system and testing solutions.

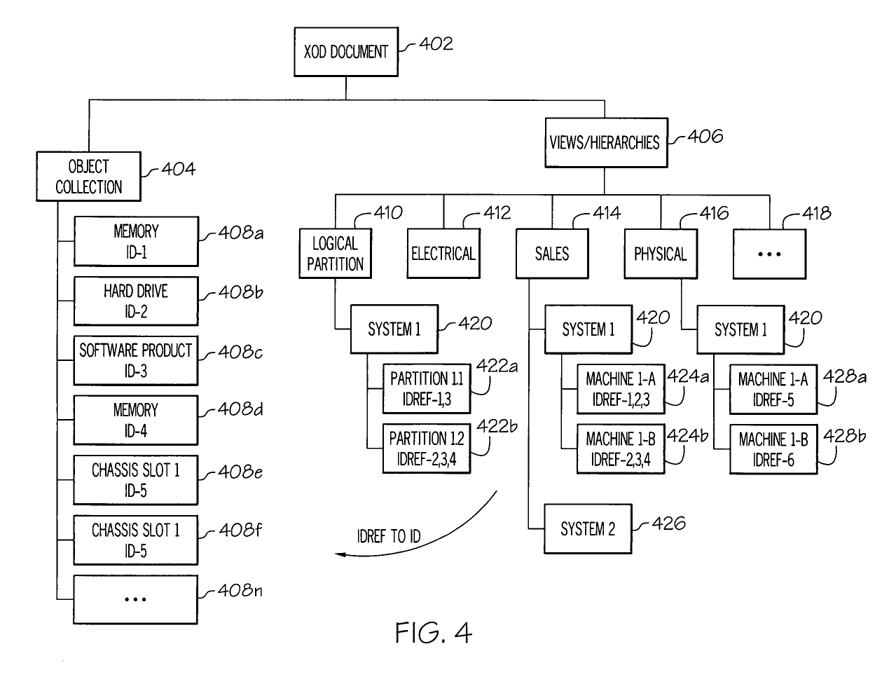

FIG. 4 is a block diagram of an XOD document and its object collection and view/hierarchies object sub-units in accordance with an illustrative embodiment of the present invention. XOD document 402 includes an object collection 404 and views/hierarchies 406. Object collection 404 is a collection of objects 408a-n, which represent specific components of a product to be manufactured, such as a System 1 420. Views/hierarchies 406 shown a logical and/or physical relationship between components (described in objects 408a-n) in System 1 420. Views/hierarchies 406 are from the viewpoint of different departments in a computer-building enterprise. For example, one department may be concerned with logical partitioning (LPAR) 410, while another may be concerned with electrical components 412. Sales 414 will usually have only a high-level concern as to what features are included in the computer system, while another department is concerned with the physical assembly 416 of the computer system, etc. (block 418). Note that the blocks 410, 412, and 416 may be part of engineering and/or manufacturing departments.

As depicted for exemplary purposes, when sales 414 built up an order sheet for a customer, System 1 420 was conceptualized as being two machines (1-a and 1-b), identified in FIG. 4 as 424a and 424b. Each component in each machine has an Identification Reference (IDREF), which corresponds to one or more Identifiers (ID) in the objects 408a-n. For example, as shown in block 424a, Machine 1-a has the memory described by object 408a, the hard drive described by object 408b, and the software described by object 408c. Machine 1-b is similar to Machine 1-a, except that Machine 1-b has a different memory (described in object 408d) than Machine 1-a.

Sales 414 may or may not provide specific details as to how System 1 is built. Thus, when the engineering/manufacturing department begins assembling System 1 420, it does so according to the instructions found in objects 428a-b, which are modified by any authorized department/person, including sales 414, the manufacturing department, or even a customer (if so authorized to access and modify XOD document 402). Thus, object 428a shows that the components of Machine 1-a are to be installed in chassis slot 1 of a blade server chassis, as described by the IDREF to ID function in which object 408e is selected for ID=5. Similarly, Machine 1-b is installed in chassis slot 2 of the blade server chassis.

Besides being physically segregated into different components, System 1 may be logically segregated into partitions, in which areas of memory, physical devices (such as hard drives), and software are dedicated for (preferably exclusive) use. For example, as shown in objects 422a-b, Partition 1.1 422a includes the memory (or area of memory) identified by object 408a and the software identified by object 408c. Similarly, Partition 1.2 422b uses the hard drive, software and memory identified by objects 408b-d.

Thus, as described in FIG. 4, object collection 404 does not care (or even “know about”) views/hierarchies 406, but views/hierarchies 406 knows how to access object collection 404 (via the IDREF to ID process) to utilize/access/install each component.

XOD document 402 is further able to establish similar relationships for components found in System 2 426.

The advantages to using XOD-enabled manufacturing are that the input data is clear, unambiguous, and structured, and may be used as direct input for manufacturing. Since XOD is XML based, the elements used and their corresponding attributes are architected and predefined. The expected value types for attributes are also architected, and can be controlled (e.g., predefined values, numeric data, and dates). Since XOD is highly structured, many of the activities that previously needed manual activity may be automated. For instance, instead of operators looking at configuration sheets to verify system configuration, verification can now be accomplished using automated software programs. In addition, as XOD is highly structured, items that cannot be automated can at least be made easier to define and perform. For example, placement of an asset label on a system enclosure may be clearly defined, wherein only predefined placement locations are allowed to be used, as well as standardizing the naming of these locations. Software tools may also be developed to graphically assist operators. XOD also enables the data entered and validated by the customer to be used by manufacturing without the need for translation or interpretation of the data. XOD also eliminates any need for configuration and other rules to be maintained and executed in multiple systems within manufacturing. With XOD, there is no need for a set of rules or tables to be maintained for the assembly operators and another set of rules or tables to be maintained for test, which consequently saves effort, eliminates the opportunity for errors, and eliminates the opportunity for different default choices for configuration decisions. XOD also simplifies the task of writing automation programs. There are many XML tools, such as XML stylesheets (XSLT), XPATH query language, and XML viewers, and programming interfaces, such as XML parsers, that facilitate the development of manufacturing software programs. XOD also enables a greater degree of customization within manufacturing. Items such as RAID configurations and DASD partition sizes may be passed to manufacturing as XOD values without requiring distinct feature codes or part numbers to be generated. The customer may specify any value (within predefined ranges if desired), which may then be captured at order time and used within the manufacturing process. XOD also provides a means for verifying order to part number translations for certain hardware and software items. Some manufacturers use part numbers in addition to XOD since some systems (e.g., inventory management, costing, warehousing, parts kitting, etc.) operate better using part numbers.

Traditional methods of high volume manufacturing first define a product type based on the customer specifications. The development process then determines the parts (defined by part numbers) that may be in the product type, and provides a list of rules specifying what to do based on different combinations of parts determined for the product type. This list of rules is translated by a manufacturing configurator, and a manufacturing operator may use the output from the manufacturing configurator to perform the manual assembly steps. The output from the manufacturing configurator and part number look ups may also be used to perform automated system operations, such as testing and operating system preloading. In some cases, manufacturing operators may use special instructions from the customer to perform additional configurations on the system.

In contrast with existing traditional manufacturing methods, embodiments of the present invention provide a mechanism for using extensible object data (XOD) created by a sales configurator to drive a high volume, highly configurable product line manufacturing process. XOD is an XML-based representation of a physical product, such as a computer system. The XOD document may be provided to manufacturing and used by the manufacturing operators to assemble the product. The XOD document comprises a list of system elements that are based on the sales view for the product.

Traditionally, a manufacturing process flow is defined by creating a template of predefined routing steps (e.g., assembly, configuration, attended test, unattended test, preload, packing, etc.) that may be needed on a given machine type. The number of predefined steps may be well over 100, since some routing steps require different environments (e.g., Operating System environments, physical stations, etc.), and some steps are used in special cases (e.g., failure debug, retries, etc.). These predefined steps can be thought of as a superset state machine of all the possible process steps. A table is also maintained in the manufacturing process which determines, for every part number which could be used on a machine type, what programs (e.g., programs to update firmware, test, configure a PCI RAID adapter) need to be executed, which process steps these programs need to be executed within the superset state machine, and the sequencing of the programs within process steps. As each order is received by manufacturing, a program is executed to determine the “particular” state machine to be used for that order, and the programs that will be executed in each of the process steps.

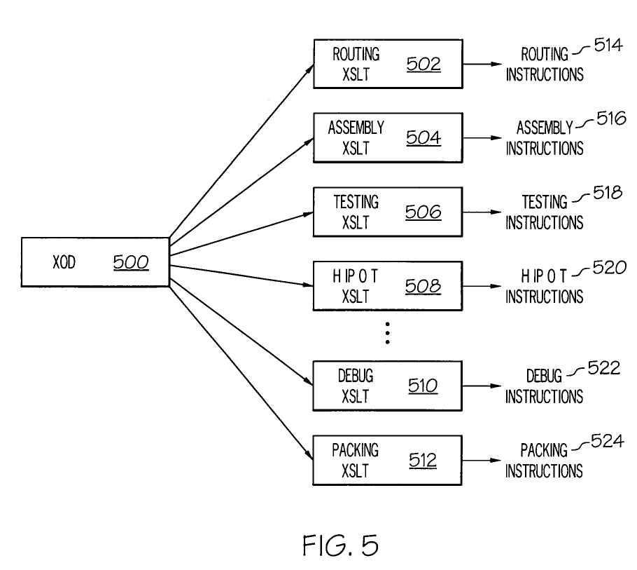

FIG. 5 is a block diagram illustrating exemplary process routing definitions generated from the XOD document in accordance with an illustrative embodiment of the present invention. In contrast with traditional manufacturing methods, the mechanism of the present invention uses XOD to provide the capability of using a more efficient method of determining the manufacturing process to run for a particular customer order. As previously mentioned, XOD describes a customized product and is used to dynamically drive a high volume manufacturing process.

In this illustrative example, XOD document 500 is used as an input to determine the manufacturing process using XML translation stylesheets (XSLT), such as Routing XSLT 502, Assembly XSLT 504, Testing XSLT 506, Hipot XSLT 508, Debug XSLT 510, Packing XSLT 512, among others. An XSLT translation stylesheet comprises rules used to transform the XOD-based product descriptions to other manufacturing outputs to create a fully defined manufacturing process definition output (i.e., a customized state machine of process routing steps or assembly instructions). The XSLT may also contain test clauses to conditionally add blocks, programs, and parameters based on content within the XOD for the order. Examples of the various manufacturing process definitions that may be generated from the XOD document include Routing instructions 514, Assembly instructions 516, Testing instructions 518, HIPOT (High Voltage Test) instructions 520, Debug instructions 522, Packing instructions 524, among others.

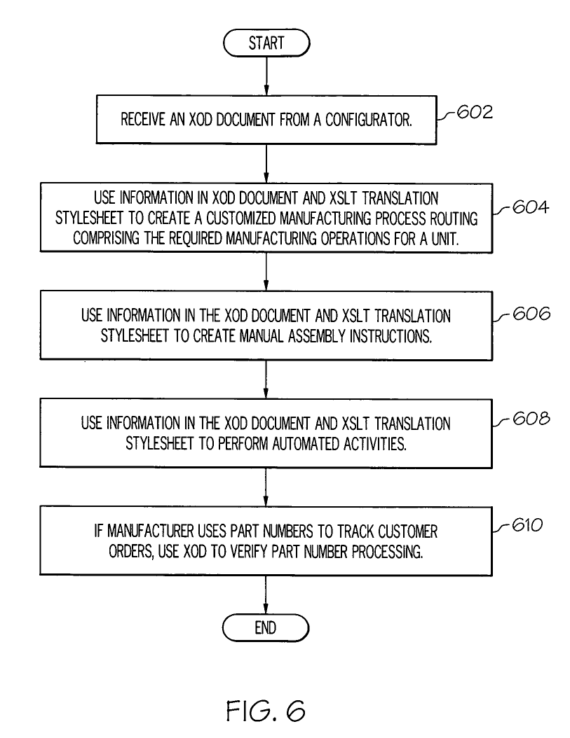

FIG. 6 is a flowchart of a process for using XOD product representation to drive manufacturing operations in accordance with an illustrative embodiment of the present invention. The XOD manufacturing process uses the XOD to: create a set of resulting manufacturing operation steps (routing steps); to direct the manual assembly steps; to perform automated system operations; and to validate part number processing. The manufacturing process of the present invention greatly reduces the set up time for new product types and new options, since it eliminates many of the communications and part number releases required in a traditional process. It also eliminates the need for the “special instructions” which are error prone and reduce manufacturing efficiency.

The process begins with receiving an XOD document from a configurator, such as from configurator 306 in FIG. 3 (step 602). The XOD document represents a customer order. Information in the XOD document and an XSLT translation stylesheet is used to create a customized manufacturing process routing comprising the required manufacturing operations for a unit based on the customer order (step 604).

Information in the XOD document and the XSLT translation stylesheet may also be used to create manual assembly instructions (step 606). XOD is useful at this point in the process for several reasons. The XOD contains the information on device placement. The XOD is also in XML format and is easy to parse by manufacturing software tools, and can be used to give operators specific information on how to assemble the unit. This is much better than many of the alternative methods (such as procedure documents which may have general guidelines such as installation fill sequences for slots, bays, etc.).

Several types of assembly instructions may be created from the XOD document. In a first example, based on the XOD content, one of several predefined XML or text files may be selected to provide the operator with general guidelines. In this case, the instructions are not customized. This example is the equivalent level of information used by many manufacturers today. In a second example, based on the XOD content, a unique XML page may be dynamically created to provide the operator with step-by-step instructions to assemble the system. In this case, the instructions are customized and provide a clearer indication of the assembly steps the operator needs to perform. In a third example, based on the XOD content, the XSLT may translate the XOD input to customized output for use by another program, such as a graphical assistant program that uses pictures with hotspots. This example will provide the clearest indication of the assembly steps the operator needs to perform. For instance, the XOD may contain a reference picture of the system along with coordinate information on component placement locations. The operator may be guided on assembling the system by showing the picture with the correct component location highlighted for each component to be installed. In a similar manner, operators can be directed to correctly install all of the components of the system (e.g., processors, memory, DASD, adapter cards, cables, etc.). All of the configuration information is contained in a structured and unambiguous manner. There is no need for additional data paths such as having a customer representative trying to convey free-form customer installation descriptions to manufacturing. Every order has information captured and shown to manufacturing operators in the same way.

Information in the XOD document and the XSLT translation stylesheet may also be used by manufacturing to perform numerous automated activities (step 608). These automated operations include verifying electronic components have been correctly assembled, configuring the system based on the customer order, updating firmware; testing the systems; preloading the operating systems, and the like. The automated activities may be performed by programs running in manufacturing. These programs should have clear, unambiguous, and structured input data to function correctly.

In particular, it is essential to verify that the system has been correctly assembled by the assembly operator. A test system (such as IBM's X3) may, by various methods, determine the parts that are in a unit, and many of the connection and configuration values. These parts and values may then be checked against the XOD data to ensure they were correctly built at manufacturing. Examples of items that may be checked for correct sizes/speeds/parameters include adapter cards, such as PCI cards, and their locations, DASD devices, such as IDE/SCSI hard drives, their locations and cabling, memory devices and their locations, CPU devices and their locations, cache devices and their locations, and the like.

Manufacturing is also required to configure systems as required by the customer order. A test system (such as IBM's X3) can automate many of these tasks by using XOD data. System preferences (such as boot sequence and power management options), RAID configurations, partitioning (such as system partitioning, DASD partitions, etc.), and OS loading and configuration can be performed using various programs and methods.

Manufacturing may also use XOD to trigger process steps such as automated firmware updates and specialized diagnostic testing. Since many devices are customer orderable options, there must be a mechanism to add manufacturing process content based on the ordered configuration. XOD allows a test system (such as IBM's X3) to dynamically generate a complete test sequence including the proper steps required based on all the installed devices. One advantage of using XOD to create a customized manufacturing process is that it is XML based. As a result, XML tools such as XSLT style sheets and XPATH can simplify the development of programs used to generate the customized manufacturing process required for each customer order.

If a manufacturer uses part numbers to track customer orders, XOD may be used to verify part number processing (step 610). In other words, XOD is used to verify customer order to part number translations for certain hardware and software items. One problem that has historically occurred when using part numbers is that errors can be introduced when adding or changing part number information. These errors can be introduced by simple typographical errors such as adding an incompatible substitute part number, such as adding a 2.2 Ghz processor as a substitute for a 2.4 Ghz processor, or by system problems which cause incorrect processing of part numbers.

Manufacturers who use part numbers in addition to XOD will have a dual path for information. The first path is the part number path, which is limited to part number numbers exclusively. This path is used for systems that work better with fixed fields to enable database look-up's (e.g., inventory management, costing, warehousing, parts kitting, etc.). The second path is the XOD path, which contains the more detailed XOD information.

Since XOD has information on the configuration specified by the customer at order time, manufacturing can perform automated test operations based on the XOD. If an error occurs in the part numbers path, an incorrect part could subsequently be specified in a system build. Although this incorrect part may then be used in the build of a system, the incorrect part will be detected during the automated test operations in step 608, since the device built in the system (the incorrect one) does not match what was specified in the customer order (the correct one). This would cause a failure in the process, which could then be analyzed and corrected.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read—only memory (ROM), a rigid magnetic disk and an optical disk. Current examples of optical disks include compact disk—read only memory (CD-ROM), compact disk-read/write (CD-R/W), and digital video disc (DVD).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for generating customized manufacturing operations, the computer implemented method comprising:
receiving a request to create an item, wherein the request includes extensible object data comprising an extensible markup language-based representation of a physical product;
generating a production order based on the request to begin the manufacturing process; and
creating a customized manufacturing process routing using the extensible object data and an extensible translation stylesheet;
wherein the customized manufacturing process routing provides manufacturing operators with specific information regarding process steps to manufacture the item specified in the request.

2. The computer implemented method of claim 1, further comprising:
creating manual manufacturing instructions using the extensible object data and the extensible translation stylesheet; and
providing the manual manufacturing instructions to the manufacturing operators.

3. The computer implemented method of claim 1, further comprising:
using the extensible object data and the extensible translation stylesheet to trigger automated operations, wherein the automated operations include at least one of verifying components in the item are correctly assembled, configuring the item based on the customer order, updating firmware in the item, and testing the item.

4. The computer implemented method of claim 1, further comprising:
responsive to determining that a manufacturer uses part numbers to track customer orders, using the extensible object data to verify part number processing.

5. The computer implemented method of claim 1, wherein verifying part number processing includes verifying request to part number translations for hardware and software items.

6. The computer implemented method of claim 1, wherein the customized manufacturing process routing includes graphics to aid manufacturing operators in correctly manufacturing the item.

7. The computer implemented method of claim 6, wherein the graphics include at least one of pictures regarding placement of devices in a system or labeling requirements.

8. The computer implemented method of claim 1, wherein the extensible object data comprises a list of components based on a sales view for the item.

9. The computer implemented method of claim 3, wherein the automated operations include verifying against the extensible object data that the item has been correctly assembled by the manufacturing operator.

10. The computer implemented method of claim 3, wherein the automated operations include configuring the item as specified in the request.

11. The computer implemented method of claim 3, wherein the automated operations include using the extensible object data and extensible translation stylesheet to trigger at least one of automated firmware updates or specialized diagnostic testing, wherein the extensible object data is used to dynamically generate a complete test sequence.

12. A data processing system for generating customized manufacturing operations, the data processing system comprising:
a bus;
a storage device connected to the bus, wherein the storage device contains computer usable code;
at least one managed device connected to the bus;
a communications unit connected to the bus; and
a processing unit connected to the bus, wherein the processing unit executes the computer usable code to receive a request to create an item, wherein the request includes extensible object data comprising an extensible markup language-based representation of a physical product, generate a production order based on the request to begin the manufacturing process, and create a customized manufacturing process routing using the extensible object data and an extensible translation stylesheet, wherein the customized manufacturing process routing provides manufacturing operators with specific information regarding process steps to manufacture the item specified in the request.

13. The data processing system of claim 12, wherein the processing unit executes the computer usable code to create manual manufacturing instructions using the extensible object data and the extensible translation stylesheet, and provide the manual manufacturing instructions to the manufacturing operators.

14. The data processing system of claim 12, wherein the processing unit executes the computer usable code to use the extensible object data and the extensible translation stylesheet to trigger automated operations, wherein the automated operations include at least one of verifying components are correctly assembled in the item, configuring the item based on the customer order, updating firmware in the item, and testing the item.

15. The data processing system of claim 12, wherein the processing unit executes the computer usable code to use the extensible object data and extensible translation stylesheet to verify part number processing in response to determining that a manufacturer uses part numbers to track customer orders.

16. A computer program product for generating customized manufacturing operations, the computer program product comprising:
a computer usable medium having computer usable program code tangibly embodied thereon, the computer usable program code comprising:
computer usable program code for receiving a request to create an item, wherein the request includes extensible object data comprising an extensible markup language-based representation of a physical product;
computer usable program code for generating a production order based on the request to begin the manufacturing process; and
computer usable program code for creating a customized manufacturing process routing using the extensible object data and an extensible translation stylesheet;
wherein the customized manufacturing process routing provides manufacturing operators with specific information regarding process steps to manufacture the item specified in the request.

17. The computer program product of claim 16, further comprising:
computer usable program code for creating manual manufacturing instructions using the extensible object data and the extensible translation stylesheet; and
computer usable program code for providing the manual manufacturing instructions to the manufacturing operators.

18. The computer program product of claim 16, further comprising:
computer usable program code for using the extensible object data and the extensible translation stylesheet to trigger automated operations, wherein the automated operations include at least one of verifying components in the item are correctly assembled, configuring the item based on the customer order, updating firmware in the item, and testing the item.

19. The computer program product of claim 16, further comprising:
computer usable program code for using the extensible object data and extensible translation stylesheet to verify part number processing in response to determining that a manufacturer uses part numbers to track customer orders.

20. The computer program product of claim 16, wherein the customized manufacturing process routing includes graphics to aid manufacturing operators in correctly manufacturing the item.
